(19) United States
(12) Patent Application Publication
(10) Pub. No.: US 2025/0172003 A1
(43) Pub. Date: May 29, 2025

(54) WALL FINISHING SYSTEM

(71) Applicant: DUROCK ALFACING INTERNATIONAL LIMITED, Woodbridge (CA)

(72) Inventor: Gary CAMPACCI, Woodbridge (CA)

(21) Appl. No.: 18/960,501

(22) Filed: Nov. 26, 2024

Related U.S. Application Data
(60) Provisional application No. 63/603,441, filed on Nov. 28, 2023.

(51) Int. Cl. E04F 13/08; E04F 13/14

(52) U.S. Cl. CPC E04F 13/0862; E04F 13/147

(57) ABSTRACT

Cladding systems for finishing an Exterior Insulation Finish Systems (EIFS) and methods of manufacturing same are provided. The cladding system comprises: a plurality of bricks coupled to an open-weave mesh in a bond pattern where a space for a mortar joint is defined by adjacent bricks. The bricks each having a length, width, and height. The open-weave mesh define a plurality of holes, each of the plurality of holes having an area configured to allow a mortar to pass through the holes to extend to at least of the height of the polymer bricks. The mortar is configured to adhere to the open-weave mesh and the bricks to couple the open-weave mesh the bricks to a substrate. The mortar has a viscosity to pass through the holes to extend at least to the height of the polymer bricks to provide a grout in the space for the mortar joint.

### CROSS REFERENCE TO RELATED APPLICATION AND CLAIM OF PRIORITY

The present application claims priority to U.S. provisional patent application No. 63/603,441 filed on Nov. 28, 2023, the entire contents of which are hereby incorporated by reference.

### TECHNICAL FIELD

The disclosure relates generally to wall finishing systems, and more particularly to cladding for Exterior Insulation and Finish Systems.

### BACKGROUND

Exterior Insulation and Finish Systems (EIFS) are non-load bearing exterior wall cladding systems that incorporates exterior continuous insulation, with a cladding that may allow architects and contractor added design flexibility and a variety of aesthetic finishes, while providing insulation to meet energy codes. An externally installed insulated finished wall surface may serve to supplement or replace internally installed building insulation such as spray foam or flexible fibrous insulation batts. Because many traditional homes have a brick exterior, there is a need to provide a cladding for an EIFS system that resembles brick.

Features that distinguish the present invention from the background art will be apparent from review of the disclosure, drawings and description of the invention presented below.

### SUMMARY

In one aspect, the disclosure describes a cladding system for finishing an Exterior Insulation Finish Systems (EIFS). The cladding system comprises: a plurality of bricks coupled to an open-weave mesh in a bond pattern where a space for a mortar joint is defined by adjacent bricks of the plurality of plurality of polymer bricks, the plurality of bricks each having a length, width, and height; the open-weave mesh defining a plurality of holes, each of the plurality of holes having an area configured to allow a mortar to pass through the holes to extend to at least of the height of the polymer bricks; and the mortar configured to adhere to the open-weave mesh and the plurality of bricks to couple the open-weave mesh the plurality of bricks to a substrate, the mortar having a viscosity to pass through the holes to extend least to the height of the polymer bricks to provide a grout in the space for the mortar joint.

In an embodiment, the open-weave mesh is a glass fiber reinforcing mesh, the glass fiber comprises fiberglass in a range of 70-90% and polymer in a range of 10-30%. The open-weave mesh may comprise about 81% fiberglass and 19% fluropolymer.

In an embodiment, the open-weave mesh is a first open-weave mesh, and the first open-weave mesh is cut in a pattern configured to interlock a second open-weave mesh of the cladding system.

In an embodiment, the plurality of bricks comprises about 10-25 wt % polymer, about 15-30 wt % calcium carbonate, about 45-60 wt % silica sand, about 0.1-10% water, about 0-5 wt % rheology modifier, and about 1-10% catalyst. In an example, the polymer is at least one of an acrylic, a styrene acrylic, and polyurethane. In another example, the first rheology modifier is at least one of cellulose ether, Hydroxyethylmethyl cellulose (HEMC), Hydroxypropylmethyl cellulose (HPMC), Hydroxyethyl cellulose (HEC), attapulgite, bentonite, hectorite, and sepiolite, and alkali-soluble/alkali swellable thickeners. In another example, the catalyst is a powdered pozzolanic material comprising at least one of volcanic ash, pumice, opaline shales, slag, burnt clay, fly ash, metakaolin, silica fume, non-ferrous slag, and portland cement. In another example, the plurality of bricks comprise a base comprising at least one of the rheology modifier, a dispersing agent, a solvent, a surfactant, an in-can preservative, a dry film preservative, a rust inhibitor, a coalescing agent, and a pH adjuster. The dispersing agent may comprise at least one of polyacrylates, polyester, polyether, polyurethane, hydrophobic copolymer polyeclectrolyte, polyacid homopolymer, polyacid copolymer, and polycarboxylic acid. The solvent may comprise at least one of an e-series glycol ether and a p-series propylene glycol ether. The surfactant may comprise at least one of: a non-ionic surfactant comprising a hydrophilic carboxylate, sulfate, sulfonate, quaternary ammonium; an ionic surfactant comprising an anionic and cationic surfactant; an amphoteric surfactant; and phosphate ester neutralized salt. The in-can preservative may comprise isothiazolinone including at least one of methylisothiazolinone (MIT), 2-methy-1,2-benzisothiazolin-3-one (MBIT), methylchloroisothiazolinone (CMIT), benzisothiazolinone (BIT), and octylisothiazolinone (OIT), sodium hypochlorite, quaternary ammonium compounds, benzyl-C8-C18-alkyldimethyl, chlorides. The dry film preservative may comprise at least one of iodopropynyl butylcarbamate (IPBC), octyl isothiazolinone (OIT), Zinc pyrithione (ZPT), and dichloro octyl isothiazolinone (DCOIT). The rust inhibitor may comprise at least one of a inorganic rust inhibitors comprising at least one of a nitrite, nitrate, chromic salt, and phosphate; and/or an organic amine. The nitrite is optionally calcium nitrite, the phosphate is optionally at least one of sodium monofluorophosphate (Na₂PO₃F)(MFP), disodium hydrogen phosphate (Na₂HPO₄)(DHP), and trisodium phosphate (Na₃PO₄)(TSP). The pH adjuster may comprise at least one of ammonia, 2-amino-2-methyl-1-propanol. The coalescing agent may comprise at least one of ester alcohol, ethylene glycol monobutyl ether, diethylene glycol monobutyl ether, an acrylic coalescing agent, dipropylene glycol dimethyl ether (DMM), and dipropylene glycol n-butyl ether (DPnB).

In an embodiment, the height of each of the plurality of bricks is in a range of 0.2-1 inch, preferably the height is about 0.25 inch.

In an embodiment, the area of each of the plurality of holes is greater than 0.4 inch², and wherein the space is in a range of 0.2-0.8 inches (0.5 mm-20 mm), preferably the area of each of the plurality of holes is about 0.6 inch².

In an embodiment, the bond pattern is any one of a running bond brick pattern, a common bond brick pattern, an English bond brick pattern, a flemish bond brick pattern, and a stack bond brick pattern.

In an embodiment, the mortar comprises: a pozzolanic material, silica sand, a second rheology modifier, redispersible polymer, calcium carbonate, a calcium inosilicate mineral, wherein the mortar comprises 30-35 wt % pozzolanice material, 40-50 wt % silica sand, 0.1-1 wt % rheology modifier, 2-5% redispersible polymer, about 0.5-1% calcium inosilicate mineral, and 10-15 wt % calcium carbonate. The pozzolanice material may comprise at least one of volcanic ash, pumice, opaline shales, slag, burnt clay, fly ash, metakaolin, silica fume, non-ferrous slag, and portland cement. The second rheology modifier may be at least one of Hydroxyethylmethyl cellulose (HEMC), Hydroxypropylmethyl cellulose (HPMC), Hydroxyethyl cellulose (HEC), Attapulgite, bentonite, hectorite, and sepiolite. The redispersible polymer may be at least one of ethylene vinyl acetate copolymer (EVA); vinyl acetate/ethylene/vinyl ester of versatic acid terpolymer (VAC/E/VeoVa); vinyl acetate/vinyl ester of versatic acid terpolymer copolymer (VAc/VeoVa), and polyvinyl acetate polymer (PVAC). The calcium inosilicate mineral may be Wollastonite. The mortar may comprise 3-5 wt % recycled material, the recycled material comprising at least one of glass and any one of polyester, nylon, cotton, wool and down fibers.

Embodiments may include combinations of the above features.

In another aspect, the disclosure describes a cladding for an EIFS system. The cladding comprises: a plurality of bricks coupled to an open-weave mesh in a bond pattern where a space for a mortar joint is defined by adjacent bricks of the plurality of plurality of bricks, the plurality of bricks each having a length, width, and height; and the open-weave mesh defining a plurality of holes, each of the plurality of holes having an area configured to allow a mortar to pass through the holes to extend at least to the height of the bricks.

In an embodiment, the open-weave mesh is a glass fiber reinforcing mesh.

In an embodiment, the glass fiber comprises fiberglass in a range of 70-90% and polymer in a range of 10-30%, preferably, the open-weave mesh 205 comprises about 81% fiberglass and 19% fluropolymer.

In an embodiment, the open-weave mesh is a first open-weave mesh, and wherein the first open-weave mesh is cut in a pattern configured to interlock a second open-weave mesh of the cladding system.

In an embodiment, the plurality of bricks comprise polymer, calcium carbonate, silica sand, water, rheology modifier, and a catalyst.

In an embodiment, the height of the bricks are in a range of 0.2-1 inch. In an example, the height is about 0.25 inch.

In an embodiment, the area of each of the plurality of holes is greater than 0.4 inch², preferably greater than 0.5 inch². In an example, the area of each of the plurality of holes is about 0.6 inch².

In an embodiment, the space is in a range of 0.2-0.8 inches (0.5 mm-20 mm).

In an embodiment, the bond pattern is any one of a running bond brick pattern, a common bond brick pattern, an English bond brick pattern, a flemish bond brick pattern, and a stack bond brick pattern.

Embodiments may include combinations of the above features.

In a further aspect, the disclosure describes a method for manufacturing a cladding system for an Exterior Insulation Finish Systems (EIFS). The method comprises: providing a composition for forming a brick; providing a plurality of templates for a bond pattern, the plurality of templates configured to interlock to form a continuous surface when one of the plurality of templates interlock with the other of the plurality of templates; positioning an open-weave mesh onto the template; extruding the composition to form a plurality of bricks, each of the bricks having a length, width, and height; positioning the plurality of bricks on the open-weave mesh in the bond pattern, the where a space for a mortar joint is defined by adjacent bricks of the plurality of plurality of bricks; coupling the plurality of bricks to the open-weave mesh; curing the plurality of bricks with a heater; cutting the open-weave mesh in the bond pattern; removing the plurality of bricks and open-weave mesh from the template.

In an embodiment, the method comprises removing the plurality of bricks and open-weave mesh from the template.

In an embodiment, the curing the plurality of with a heater comprises heating the plurality of bricks to a temperature greater than 50° C., preferable at least 55° C.

In an embodiment, the open-weave mesh defines a plurality of holes, each of the plurality of holes having an area configured to allow a mortar to pass through the holes to extend at least of a height of the polymer bricks.

In an embodiment, the plurality of bricks are coupled to the open-weave mesh in a bond pattern where a space for a mortar joint is defined by adjacent bricks of the plurality of plurality of polymer bricks, the plurality of bricks each having a length, width, and height.

In an embodiment, the method comprises continuously interlocking the plurality of templates to form the continuous surface on which the open-weave and the plurality of bricks are positioned in a continuous process.

In an embodiment, the open-weave mesh is a glass fiber reinforcing mesh.

In an embodiment, the open-weave mesh is a first open-weave mesh, and the first open-weave mesh is cut in a pattern configured to interlock a second open-weave mesh of the cladding system.

In an embodiment, the plurality of bricks comprise polymer, calcium carbonate, silica sand, water, rheology modifier, and a catalyst.

In an embodiment, the height of the bricks are in a range of 0.2-1 inch. In an example, the height is about 0.25 inch.

In an embodiment, the area of each of the plurality of holes is greater than 0.4 inch², optionally greater than 0.5 inch².

In an embodiment, the area of each of the plurality of holes is about 0.6 inch².

The method of any one of claims 22-34, wherein the space is in a range of 0.2-0.8 inches (0.5 mm-20 mm).

In an embodiment, the bond pattern is any one of a running bond brick pattern, a common bond brick pattern, an English bond brick pattern, a flemish bond brick pattern, and a stack bond brick pattern.

Embodiments may include combinations of the above features.

Further details of these and other aspects of the subject matter of this application will be apparent from the detailed description included below and the drawings.

### DESCRIPTION OF THE DRAWINGS

Reference is now made to the accompanying drawings, in which:

FIG. 1 shows a prior art Exterior Insulation and Finish System;

FIG. 2 is a perspective view of an example cladding system for finishing an Exterior Insulation Finish System according to this disclosure;

FIG. 3 is a plan view of the example cladding system shown in FIG. 2;

FIG. 4 is a rear perspective view example cladding system shown in FIG. 2; and

FIG. 5 is a plan view of the mesh of the example cladding system shown in FIG. 4;

FIG. 6 is a plan view of an example cladding system and mortar according to this disclosure coupled to a wall;

FIG. 7 is a perspective view of an example cladding system coupled to a substrate with the mortar being tooled into a mortar joint;

FIG. 8 is a schematic view of an example method for manufacturing a cladding system for an Exterior Insulation Finish Systems; and

FIG. 9A and FIG. 9B are a schematic views illustrating the example method for manufacturing a cladding system of FIG. 8.

### DETAILED DESCRIPTION

This disclosure describes cladding for finishing Exterior Insulation and Finish System (EIFS) which may provide sustainable, cost-effective, and easy to install, brick-like designs for facades of buildings. The cladding according to this disclosure may also improve energy efficiency of the EIFS due to the cladding's improved resistivity to heat transfer in comparison to exterior layers of traditional EIFS.

Clay brick has long been a cladding of choice for all building types, but clay brick is not an environmentally sustainable building material. In order to preserve the brick appearance for future generations, this disclosure provides materials, systems, and methods to manufacture said systems, which simulate brick while reducing carbon emissions in comparison to brick. Additionally, bricklayers are leaving the workforce at a much faster pace than new ones are entering it, so to compensate for the decrease in workforce cladding systems for EIFS according to this disclosure may provide with a readily available and easy to install system that reduces installation time.

Cladding for finishing EIFS according to this disclosure may provide a light-weight finish system that resembles clay brick, and when used as a finish for EIFS cladding, may provide a light-weight, cost-effective, environmentally-friendly, energy-efficient alternative to clay brick. Notably, EIFS has lower embodied carbon than clay brick and buildings clad with EIFS emit less operational carbon than those clad with clay brick.

Clay brick may not provide thermal resistance whereas insulation and air barriers may be components of EIFS and provide thermal resistance. Characteristically EIFS water resistive barriers are air barriers as well, thereby making the walls airtight and further reducing energy loss. Cladding according to this disclosure may enable EIFS to deliver the aesthetics of clay brick without the associated detrimental effects to the environment all while reducing the operational emissions of the building as a result of the inherent insulation in EIFS and the cladding.

Additionally, cladding for EIFS according to this disclosure may be attached directly to a supporting wall, so that it does not require the foundational support that clay brick requires. This can result in smaller foundations with less carbon-emitting concrete and walls that can be constructed closer to property lines because the cladding can be situated above the foundation rather than outboard of it.

Cladding according to this disclosure may be a brick made of thin polymer, e.g. acrylic, overlay manufactured in sheets that are applied onto open-weave mesh backing. The brick sheets may then be site-applied to the back-up wall of the EIFS, where an adhesive mortar not only fixes the bricks to a substrate, e.g. wall, but also serves as the grout material that is then tooled to resemble brick mortar joints. The bricks of the cladding may be coupled the open-weave mesh in a bond pattern where the open-weave mesh has a hole size large enough to enable the adhesive mortar to pass through the holes. When installed, pressing the cladding into the adhesive mortar on a wall pushes the mortar through the holes into spaces between the bricks so that it can be used as a mortar joints. The combination of the open-weave mesh and adhesive mortar acting as both an adhesive to couple the bricks to a wall and as the mortar joint, may provide an easy-to-install cladding for EIFS.

### Definitions

Although terms such as “maximize”, “minimize” and “optimize” may be used in the present disclosure, it should be understood that such term may be used to refer to improvements, tuning and refinements which may not be strictly limited to maximal, minimal or optimal.

The term “connected” or “coupled to” may include both direct coupling (in which two elements that are coupled to each other and contact each other) and indirect coupling (in which at least one additional element is located between the two elements).

The term “substantially” as used herein may be applied to modify any quantitative representation which could permissibly vary without resulting in a change in the basic function to which it is related.

Terms such as “up to”, “at least”, “greater than”, “less than”, “more than”, “or more”, and the like, include the number recited and such terms refer to ranges that can be subsequently broken down into sub-ranges. In the same manner, all ratios recited herein also include all sub-ratios falling within the broader ratio.

The singular forms “a,” “an,” and “the” include the plural reference unless the context clearly dictates otherwise. The term “and/or” means any one of the items, any combination of the items, or all of the items with which this term is associated.

The term “about” can refer to a variation of ±5%, ±10%, ±20%, or ±25% of the value specified. For example, “about 50” percent can in some embodiments carry a variation from 45 to 55 percent. For integer ranges, the term “about” can include one or two integers greater than and/or less than a recited integer at each end of the range. Unless indicated otherwise herein, the term “about” is intended to include values and ranges proximate to the recited range that are equivalent in terms of the functionality of the composition, or the embodiment.

The term “Exterior Insulation Finish Systems” (EIFS) can refer to a non-load bearing, exterior wall cladding system that comprises of an insulation board attached either adhesively or mechanically, or both, to the substrate; an integrally reinforced base coat; and a textured protective finish coat. This type of system is may be referred to as artificial stucco.

The term “Bond Pattern” is the pattern in which the polymer bricks are laid on the open-weave mesh according to this disclosure.

The term “Template” refers to a tray for receiving open-weave mesh and brick of the cladding system according to this disclosure. Each tray may be configured to interlock to provide a continuous surface for receiving open-weave mesh and brick of the cladding system according to this disclosure.

Aspects of various embodiments are described through reference to the drawings.

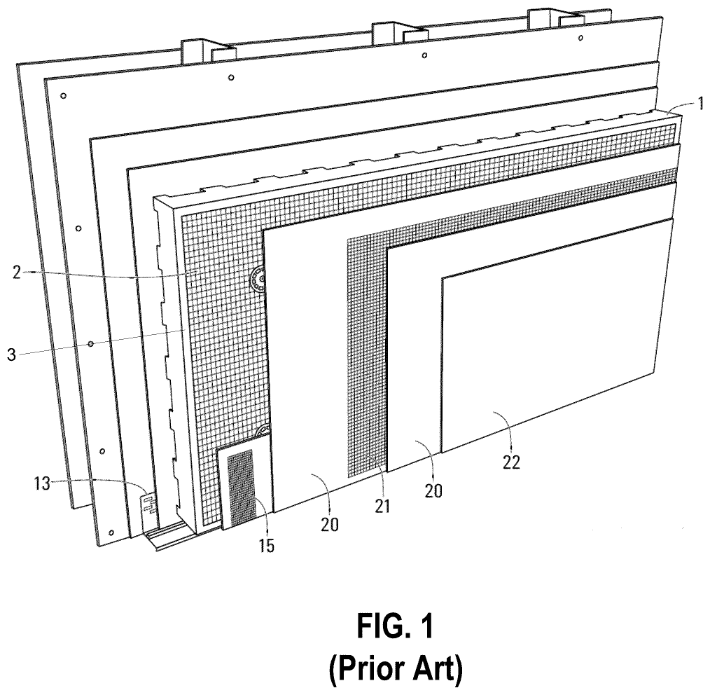

FIG. 1 is a prior art example of Exterior Insulation Finish Systems (EIFS). Insulation board 1 may be made of various materials such as foamed plastic polystyrene or mineral wool. In FIG. 1, insulation board 1 is mineral wool made of mechanically entangled non-woven hydrophobic fibers spaced apart by air voids and defining a flexible compressive fibrous mass. In the example shown, a reinforcing fiber mesh 2 is adhered to the front surface apart from the peripheral edge area 3 that is free of mesh. Multiple insulation boards 1 may be installed on a wall surface side-by side with abutting joints. The reinforcing mesh 2 comprises a grid of overlapping strands of twisted fibers and can be adhered or bonded to the front surface of the insulation board 1 with an adhesive. Bottom edge wrap fiber mesh 15 is installed to wrap the bottom edge of the mineral wool insulation board 1. Mesh 15 may be overlaid with a preparation (prep) coat layer 19. A prep coat 20 is applied over the fiber mesh 2 on the front surface of insulation board 1. An additional fiber mesh 21 is embedded in the prep coat 20 and after the prep coat 20 is cured, the exterior finish coating 22 is applied. In other examples of EIFS, such as those that use foamed plastic polystyrene insulation boards, reinforcing fiber mesh 2, 15 is not required, and prep coat 20 and exterior finish coating 22 may be applied to the insulation board 1. However, because many traditional homes have a brick exterior, there is a need to provide a cladding for an EIFS system that resembles brick.

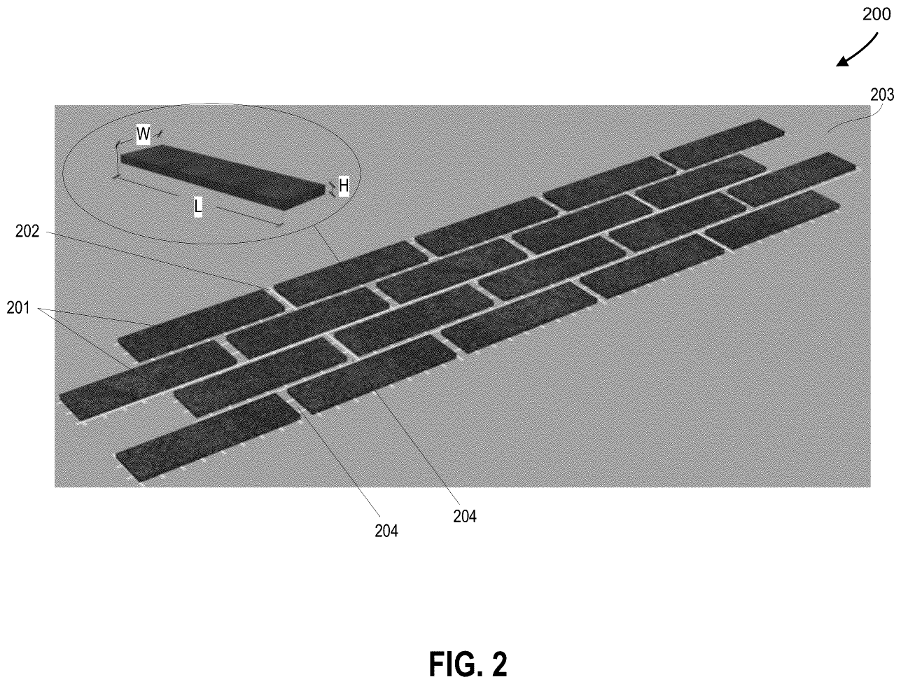

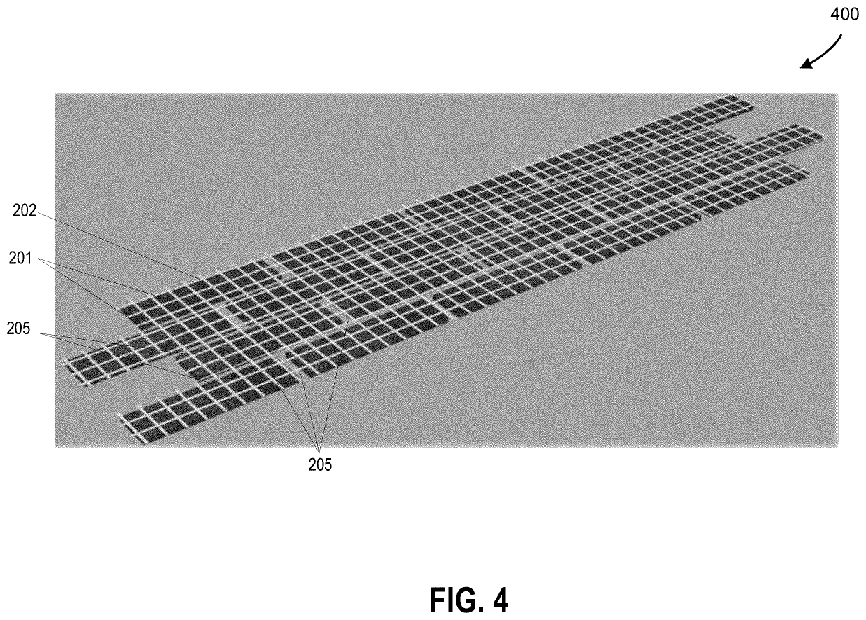

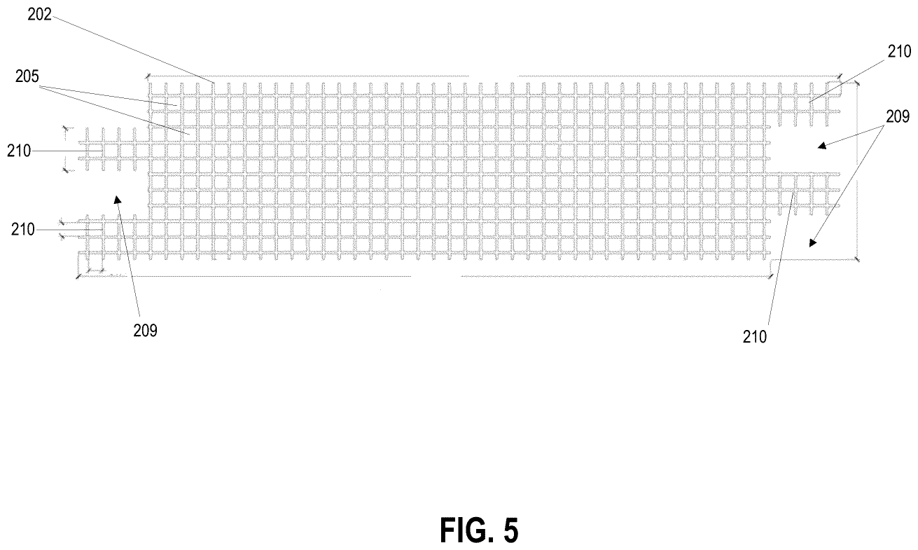

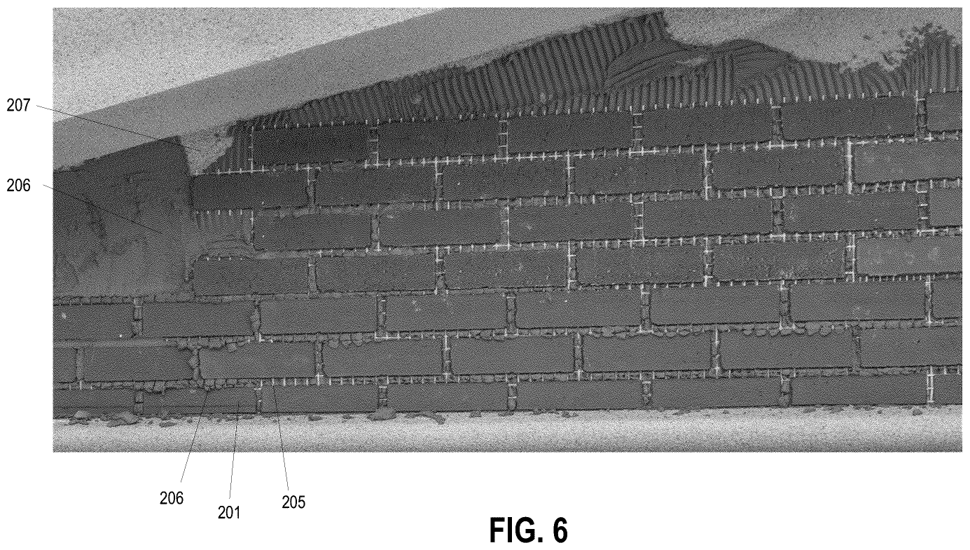

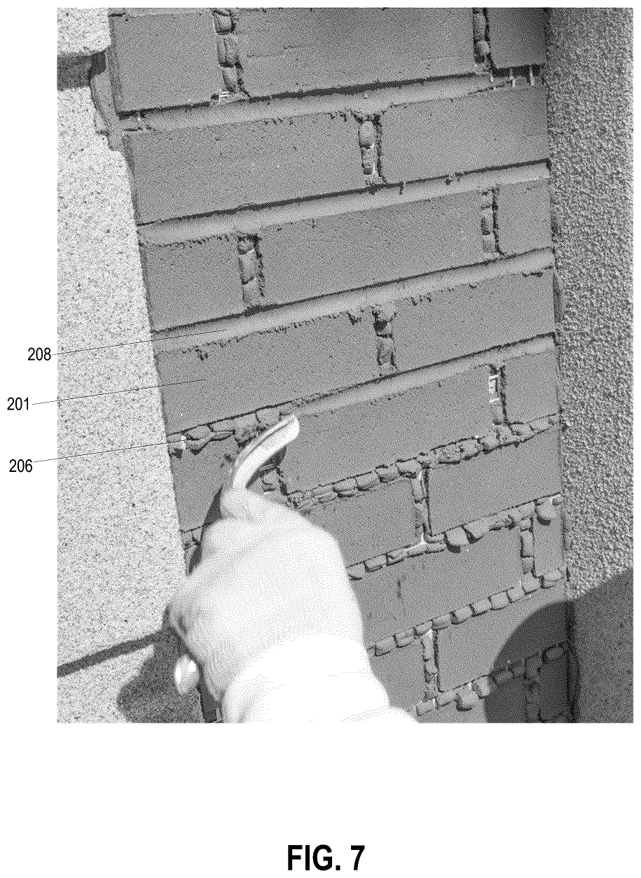

FIG. 2 shows a perspective view of an example cladding system 200 for finishing an Exterior Insulation Finish Systems (EIFS). Cladding system 200 may comprise a plurality of bricks 201 coupled to an open-weave mesh 202 in a bond pattern 203. In an embodiment, the bond pattern is any one of a running bond brick pattern, a common bond brick pattern, an English bond brick pattern, a Flemish bond brick pattern, and a stack bond brick pattern. The bond pattern illustrated in FIG. 2 is a running bond brick pattern. A space 204 for a mortar joint is defined by adjacent bricks of the plurality of plurality of bricks 201. The distance of space 204 between adjacent bricks 201 may in a range of 0.2-0.8 inches (0.5 mm-20 mm). The plurality of bricks 201 each have a length (L), width (W), and height (H). In some embodiments, the plurality of bricks 201 each have about the same length, width, and height. Plurality of bricks 201 may be overlaid onto open-weave mesh 202 defining a plurality of holes 205. FIGS. 4 and 5 illustrate open-weave mesh 202 defining the plurality of holes 205. Each of the plurality of holes 205 may have an area configured to allow a mortar to pass through the holes 205 to extend at least to the height H of the bricks 201. As shown in FIGS. 6 and 7, the mortar 206 may be configured to adhere to the open-weave mesh 202 and the plurality of bricks 201 to couple the open-weave mesh 202 and the plurality of bricks to substrate 207. In an example, substrate 207 may be a wall, or prep coat 20 and/or exterior finish coating 22 of an EIFS. Mortar 206 may have a viscosity configured to pass through the holes to extend at least of the height H of the polymer bricks to provide a grout in the space 204 for the mortar joint. As shown in FIGS. 6 and 7, mortar 206 adheres to both the surface of bricks 201 facing the substrate 207 and passes through the holes 205 of open-weave mesh 202 as the mesh 202 and bricks 201 are pressed into mortar 206. Subsequently, the mortar may be tooled into a mortar joint 208 between the plurality of bricks 201.

In an embodiment, mortar 206 is configured to act as an adhesive and have a viscosity high enough to hold open-weave mesh 202 and bricks 201 in place while the mortar 206 is still wet; and mortar 206 is configured to act as grout and have a viscosity low enough to pass through the holes 205 of open-weave mesh 202 easily and be tooled after the mortar 206 couples cladding system 200 to a substrate. In an example, a water-to-mortar ratio may be selected to provide a desired viscosity. The composition of the mortar 206 was developed to satisfy both of these requirements. In an example, the mortar 206 is configured to couple about a 100 grams brick to a substrate. Additionally, mortar 206 acts as a grouts which also resists weathering and exposure to the elements, which adhesive compound are not typically configured to do as adhesives are typically not left exposed. In an example, mortar 206 acting as a grout may be resistive to impact, mildew, fungus, salt, UV degradation. Example compositions for a mortar according to this disclosure and described below and shown in Table 1.

Mortar 206 may comprise at pozzolanic material, silica sand, a rheology modifier, calcium carbonate, calcium inosilicate mineral(s), e.g. Wollastonite. In an embodiment, the mortar comprises about 20-40% pozzolanic material, about 40-55% silica sand, about 0.1-5% rheology modifier, and about 5-20% calcium carbonate. In another embodiment, the mortar comprises about 30-35% pozzolanic material, about 45-50% silica sand, about 0.5-1% rheology modifier, about 2-5% redispersible polymer, about 0.5-1% calcium inosilicate mineral(s), e.g. Wollastonite, and about 10-15% calcium carbonate. In another embodiment, the mortar comprises recycled material. The recycled material may be present in the mortar in a range of about 0-10 wt %, or more preferably in a range of about 3-5 wt %.

In an embodiment, the pozzolanic material comprises at least one of volcanic ash, pumice, opaline shales, slag, burnt clay, fly ash, metakaolin, silica fume, non-ferrous slag, and portland cement.

In an embodiment, the rheology modifier is at least one of cellulose, such as Hydroxyethylmethyl cellulose (HEMC), Hydroxypropylmethyl cellulose (HPMC), Hydroxyethyl cellulose (HEC), and/or clay including minerals thereof such as Attapulgite, bentonite, hectorite, and/or sepiolite.

In an embodiment, the redispersible polymer is at least one of ethylene vinyl acetate copolymer, ethylene/vinyl chloride/vinyl laurate terpolymer, and Vinyl Acetate/Ethylene/Vinyl Ester of Versatic Acid Terpolymer.

In an embodiment, the recycled material is recycled glass, such as granulated glass which may be granulated and blown in a rotary kiln to provide an aggregate, and/or recycled fibres such as any one of polyester, nylon, cotton, wool and down fibers.

In an embodiment, the silica sand may have a particle size in a range suitable to pass through US Mesh 40 to US Mesh 140.

In an embodiment, the redispersible polymer is at least one of ethylene vinyl acetate copolymer (EVA), Vinyl Acetate/Ethylene/Vinyl Ester of Versatic Acid Terpolymer (VAC/E/VeoVa), Vinyl Acetate/Vinyl Ester of Versatic Acid Terpolymer Copolymer (VAc/VeoVa), and Polyvinyl Acetate Polymer (PVAC).

An example composition for a mortar according to this disclosure is described in Table 1.

TABLE 1
An Example Composition of Adhesive Mortar

| MATERIALS | % RANGE |
|---|---|
| Pozzolanic Material | 30-35% |
| Recycled Material | 3-5% |
| Silica Sand | 45-50% |
| Rheology Modifier | 0.5-1% |
| Redispersible Polymer | 2-5% |
| Calcium inosilicate mineral (e.g. | 0.5-1% |
| Wollastonite) | |
| Calcium Carbonate | 10-15% |

In an embodiment, open-weave mesh 205 is a glass fiber reinforcing mesh. In an example, open-weave mesh 205 comprises fiberglass in a range of 70-90% and polymer, e.g. fluropolymer, in a range of 10-30%. Preferably, the open-weave mesh 205 comprises about 81% fiberglass and 19% fluropolymer. Open-weave mesh 205 may have an average breaking strength of greater than 35 kN/m, preferably greater than about 43 kN/M (Warp) and 40 kN/m (Weft) according to ISO 4606. In some embodiments, open-weave mesh is a double leno weave for conveying dimensional stability, an also to keep the mesh strands flat and reduce thickness. Roving may be used in warp instead of yarns to make open-weave mesh it flatter (unlike yarn, roving has no torsion).

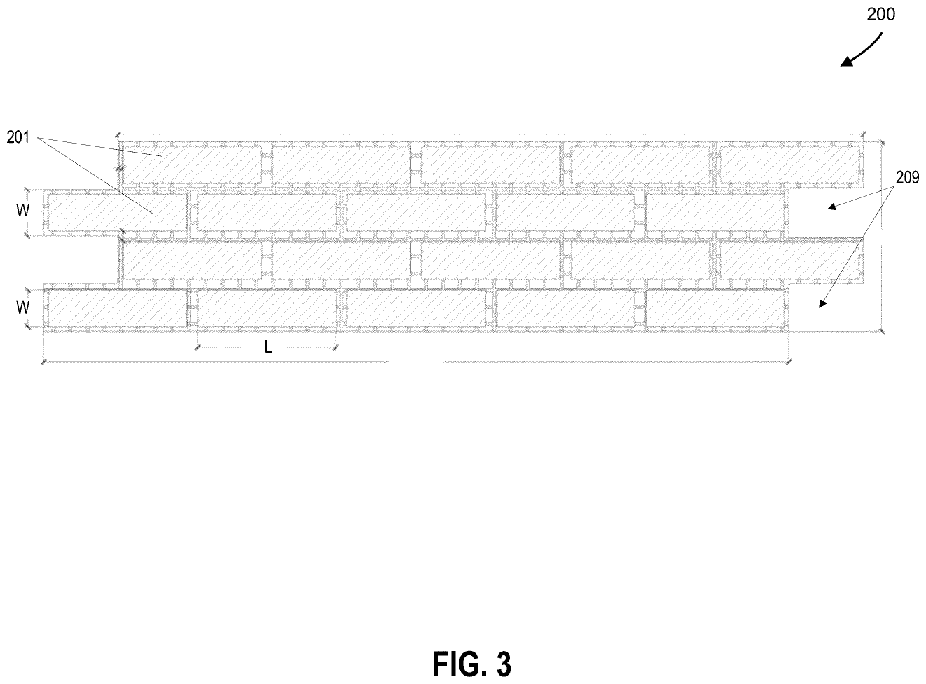

In some embodiments, open-weave mesh 205 may be a first open-weave mesh cut in a pattern configured to interlock a second open-weave mesh of the cladding system 200. As shown in FIG. 3, the bond pattern may be formed of a plurality of rows each having an equal number of bricks 201, where each row of bricks is offset such that a perimeter of the bricks forms gaps 209 for receiving a brick from an adjacent cladding system. Each row does not need to have an equal number or size or brick as other bond patterns may be used to arrange bricks 201. As shown in FIG. 5, open-weave mesh 205, and bricks 201 positioned thereon, define gaps 209 on the lateral sides of open-weave mesh 205 for receiving projections 210 of adjacent open-weave mesh and bricks of cladding system 200. Similarly, projections 210 shown in FIG. 5 fit within a gap 209 of an adjacent open-weave mesh and bricks of cladding system 200. As a result, the adjacent open-weave mesh and bricks parts of the cladding system 200 may interlock which simplifies installation and alignment of bricks 201 of adjacent parts of cladding system 200.

In an embodiment, an area of each of the plurality of holes 205 is greater than 0.4 inch², preferably greater than 0.5 inch². In an example, the area of each of the plurality of holes is about 0.6 inch².

Bricks 201 are configured to be thermally resistive and may be made from a composition that is extrudable substantially in the shape of a brick facade. The bricks 201 may be extruded into a brick shape such as the brick shape shown in FIG. 2.

In an embodiment, the composition for forming bricks 201 comprises a polymer, calcium carbonate, silica sand, water, rheology modifier, and a catalyst. In an embodiment, the polymer comprises 10-25 wt % polymer, 15-30 wt % calcium carbonate, 45-60 wt % silica sand, 0.1-10% water, 0-5 wt % rheology modifier, 1-10% catalyst. As described below, the catalyst may be a pozzolanic material which may form a pozzolanic reaction between the calcium carbonate, polymer, silica sand in the brick and the and mortar to create chemical bond(s) between the mortar and brick. This may improve adhesion between the brick, mortar, and substrate. The pozzolanic reactivity may be a function of the pozzolanic materials reaction with calcium hydroxide (lime, CH) in the presence of moisture to produce the binding product calcium-silicate-hydrate (C S H).

The composition for forming bricks 201 may also comprise a base. In an embodiment, the composition for forming bricks 201 may comprise base in a range of 5-7 wt %, polymer in a range of 15-20 wt %, the calcium carbonate in a range of 20-25 wt %, the silica sand in a range of 50-55 wt %, the water in a range of 1-5 wt %, the rheology modifier in a range of 1-5 wt %, and the catalyst in a range of 5-7 wt %. In some embodiments, the composition for forming bricks 201 comprises 0.5-2 wt % additives.

In an embodiment, the polymer of the composition for forming bricks 201 is at least one of an acrylic polymer, styrene acrylic, and polyurethane.

In an embodiment, the calcium carbonate of the composition for forming bricks 201 has a particle size in a range suitable to pass through US Mesh 16 to US Mesh 140.

In an embodiment, the silica sand of the composition for forming bricks 201 has a particle size in a range suitable to pass through US Mesh 30 to US Mesh 140.

In an embodiment, the base of the composition for forming bricks 201 may comprise at least one of a rheology modifier, dispersing agent, solvent, surfactant, coalescing agent, in-can/dry film preservative, rust inhibitor, pH adjuster, and biocides, which may modify the extrusion and drying characteristics of the bricks as they are formed. Each of the rheology modifier, dispersing agent, solvent, surfactant, coalescing agent, in-can preservative used to preserve products in their liquid form, dry film preservative to prevent biological growth on the cured product in-service, rust inhibitor (e.g. flash rust inhibitor), pH adjuster (neutralizer) may amount to 0-2 wt % of the composition for forming bricks 201. The base may comprise about 5-7% of the composition for forming bricks 201.

An example composition of the base according to this disclosure is described in Table 2.

TABLE 2
An Example Composition of a Base for Forming Bricks.

| Materials | % Range |
|---|---|
| Water | 3.0-3.5% |
| Dispersing Agent | 0.1-0.15% |
| Rheology Modifier | 0.5-1.0% |
| Surfactant | 0.1-0.15% |
| Dry Film Preservative | 0.2-0.3% |
| In-Can Preservative | 0.1-0.2% |
| Coalescing Agent | 0.3-0.4% |
| Solvent | 0.5-0.6% |
| pH Adjuster | 0.05-0.1% |
| Rust Inhibitor (Flash Rust Inhibitor) | 0.05-0.1% |

In an embodiment, the rheology modifier of the composition for forming bricks 201 may comprise cellulose, such as Hydroxyethylmethyl cellulose (HEMC), Hydroxypropylmethyl cellulose (HPMC), Hydroxyethyl cellulose (HEC), and clay, such as Attapulgite, bentonite, hectorite, sepiolite.

In an embodiment, the dispersing agent of the composition for forming bricks 201 may comprise at least one of polyacrylates, polyester, polyether, polyurethane, hydrophobic copolymer polyeclectrolyte, polyacid homopolymer, polyacid copolymer, and polycarboxylic acid.

In an embodiment, the solvent(s) of the composition for forming bricks 201 may comprise E-series glycol ether(s) including methyl, ethyl, butyl glycol ether; and P-series propylene glycol ethers, e.g. propylene oxide reacted with a chain alcohol.

In an embodiment, the surfactant(s) of the composition for forming bricks 201 may comprise at least one of non-ionic, ionic, and amphoteric surfactant(s). In an example a non-ionic surfactant may comprise a hydrophilic carboxylate, sulfate, sulfonate, quaternary ammonium, and/or sulfonic acid. In an example, an ionic surfactant includes anionic and cationic surfactants. Other surfactants include phosphate ester neutralized salt.

In an embodiment, the in-can preservative of the composition for forming bricks 201 may comprise at least one of isothiazolinone such as methylisothiazolinone (MIT), 2-methy-1,2-benzisothiazolin-3-one (MBIT), methylchloroisothiazolinone (CMIT), benzisothiazolinone (BIT), and octylisothiazolinone (OIT), sodium hypochlorite, quaternary ammonium compounds, benzyl-C8-C18-alkyldimethyl, chlorides, and combination thereof.

In an embodiment, the dry film preservative of the composition for forming bricks 201 may comprise at least one of iodopropynyl butylcarbamate (IPBC), octyl isothiazolinone (OIT), Zinc pyrithione (ZPT), and dichloro octyl isothiazolinone (DCOIT).

In an embodiment, the rust inhibitor(s) of the composition for forming bricks 201 may comprise at least one of inorganic rust inhibitors comprising nitrite (e.g. calcium nitrite), nitrate, chromic salt, and phosphate (e.g. sodium monofluorophosphate (Na₂PO₃F)(MFP), disodium hydrogen phosphate (Na₂HPO₄)(DHP), and trisodium phosphate (Na₃PO₄)(TSP)); and organic type inhibitors comprising organic amine inhibitors.

In an embodiment, the pH adjuster(s) of the composition for forming bricks 201 may comprise at least one of ammonia, organic amine (2-amino-2-methyl-1-propanol).

In an embodiment, coalescing agents of the composition for forming bricks 201 may comprise at least one of Ester alcohol, Ethylene glycol monobutyl ether, Diethylene glycol monobutyl ether, acrylic coalescing agents, and/or polymeric coalescing agents, such as dipropylene glycol dimethyl ether (DMM) and dipropylene glycol n-butyl ether (DPnB).

In an embodiment, the additives of the composition for forming bricks 201 may comprise at least one of a defoamer (e.g. emulsion of polyether-modified polydimethysiloxane with hydrophobic solids, polysiloxane, mineral hydrocarbons with silica dispersions, mineral oil with hydrophobes, mineral oil with surface active materials, anhydrous silicone, polymeric), light stabilizer/UV absorber (e.g. hindered amine light stabilizer, hydroxyphenyl-triazine), and/or colour die.

In an embodiment, the catalyst of the composition for forming bricks 201 may be pozzolanic material, e.g. powdered pozzolanic material, comprising at least one of fly ash, metakaolin, silica fume, non-ferrous slag, portland cement, volcanic ash, pumice, opaline shales, and burnt clay, for causing a cementious reaction. In an example, the powdered pozzolanic material may have an average particle size of between 10 μm to 25 μm.

In an embodiment, the rheology modifier of the composition for forming bricks 201 is at least one of Cellulose (e.g. Hydroxyethylmethyl cellulose (HEMC), Hydroxypropylmethyl cellulose (HPMC), Hydroxyethyl cellulose (HEC); clay (e.g. Attapulgite, bentonite, hectorite, sepiolite); hydrophobically-modified alkali soluble/swellable emulsion thickener (HASE), and hydrophobically-modified ethylene oxide-based urethane (HEUR).

TABLE 3
Example Compositions for brick according to this disclosure

| | |
|---|---|
| Base | 5-7% |
| Polymer | 15-20% |
| Calcium Carbonate | 20-25% |
| Silica Sand | 50-55% |
| Additives | 0.5-2% |
| Water | 1-5% |
| Rheology Modifier | 1-3% |
| Pozzolanic Material | 5-7% |
| (Catalyst) | |

In an embodiment, height (H) of bricks 201 may be in a range of 0.2-1 inch, preferably the height is about 0.25 inch. As shown in FIG. 2, the height is the dimension extending from opposing rear to the front face of the brick.

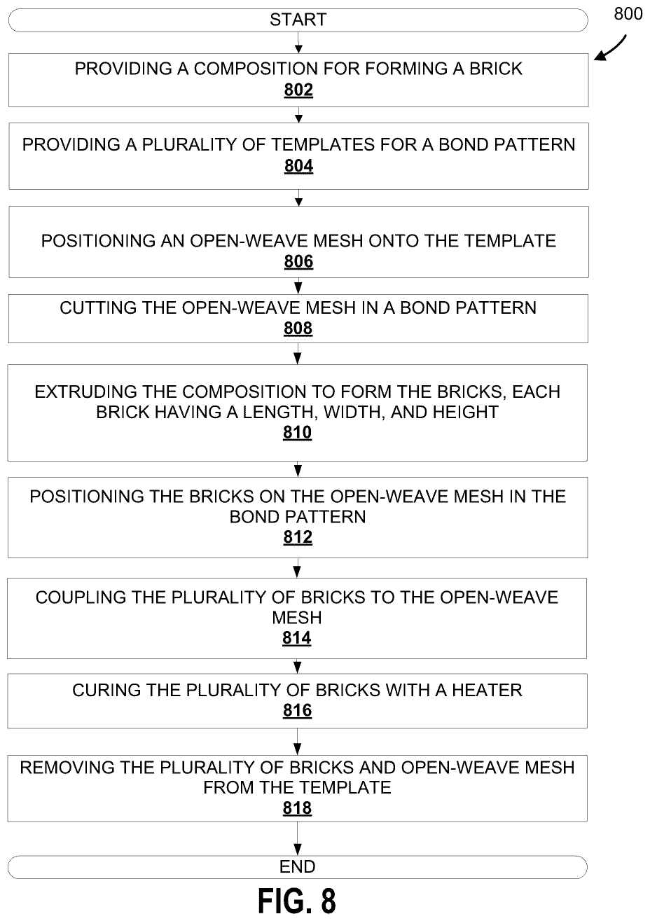

FIG. 8 shows a schematic diagram of an example method 800 for manufacturing a cladding system for an Exterior Insulation Finish Systems (EIFS), such as cladding system 200 according to this disclosure.

At 802, method 800 comprises providing a composition for forming a brick. In an embodiment, the plurality of bricks comprise polymer, e.g. acrylic.

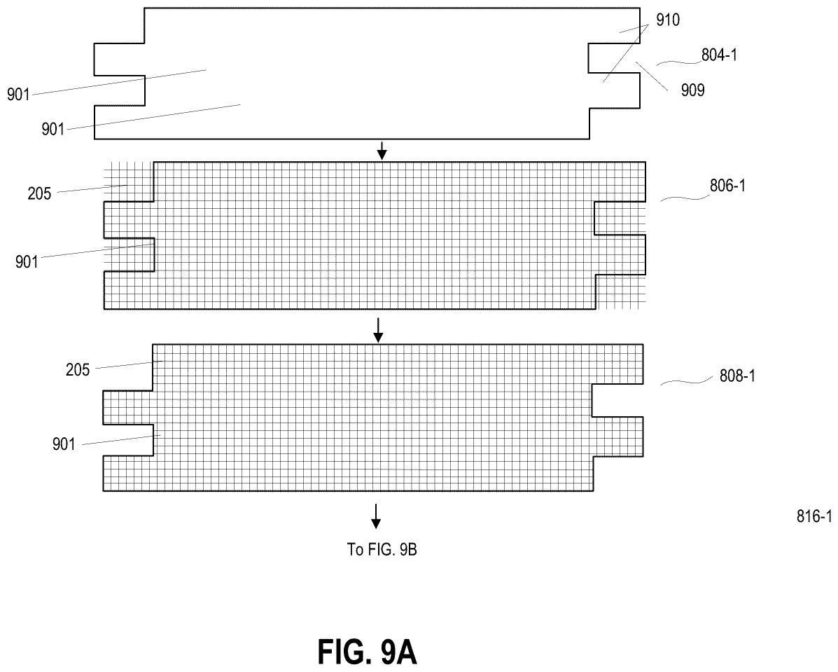

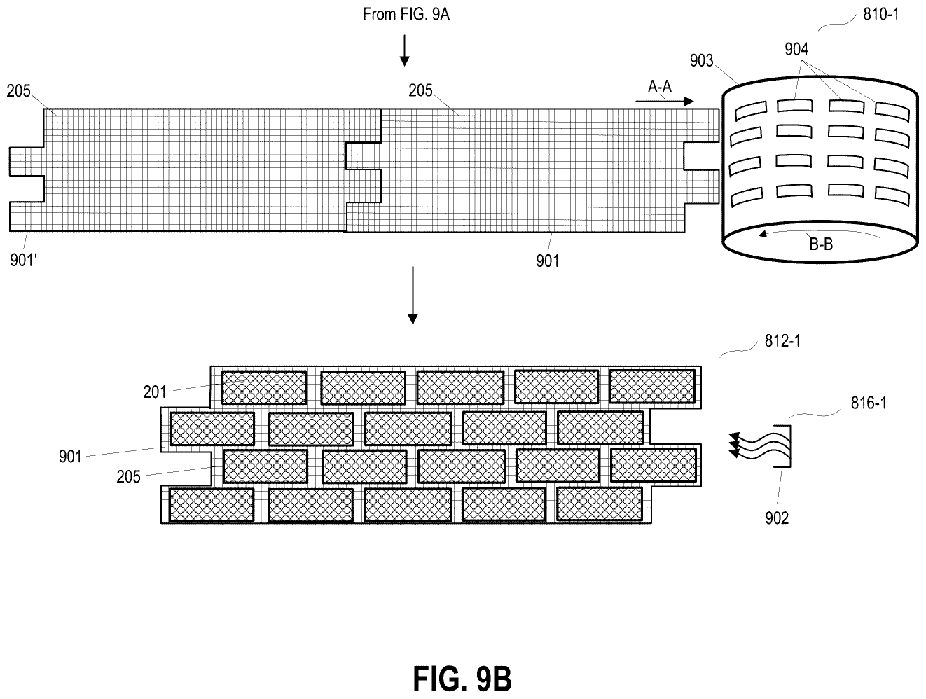

At 804, a plurality of templates 901 for a bond pattern are provided. As shown at 804-1 in FIG. 9A, plurality of templates 901 may be configured to interlock to form a continuous surface where one of the plurality of templates 901 interlock with another of the plurality of templates. Each template 901 may comprise projections 910 and gaps 209 on the lateral sides of template 901 for receiving projections 910 of adjacent templates 201. In some embodiments, method 800 comprises continuously interlocking a plurality of templates 901 to form a continuous surface on which the open-weave mesh and the plurality of bricks are positioned in a continuous process. This may allow cladding systems, such as cladding system 100, to be produced continuously. An example of template 901 interlocking with template 901′ is shown in FIG. 9B.

At 806, an open-weave mesh is positioned onto the template. As shown in 806-1 of FIG. 9A, open-weave mesh 205 may be positioned on the surface of template 901. The open-weave mesh may define a plurality of holes, each of the plurality of holes having an area configured to allow a mortar to pass through the holes to extend at least of a height of the polymer bricks. In an embodiment, the open-weave mesh is a glass fiber reinforcing mesh. The area of each of the plurality of holes may be greater than 0.4 inch², preferably greater than 0.5 inch². In an specific example, the area of each of the plurality of holes is about 0.6 inch².

At 808, the open-weave mesh is cut in the bond pattern. As shown FIG. 9A at 808-1, the open-weave mesh may be cut around the perimeter of template 901. In an embodiment, the open-weave mesh is cut into at least a first open-weave mesh on template 901 and a second open-weave mesh on another template 901′ which may be substantially the same as template 901 (shown in FIG. 9B), where the first open-weave mesh is cut in a pattern configured to interlock the second open-weave mesh.

At 810, the composition is extruded to form a plurality of bricks, each of the bricks having a length, width, and height. In some embodiments, the plurality of bricks each have about the same length, width, and height. In an example, the height of the bricks may be at least 0.2 inches, e.g. in a range of 0.2-1 inch. The length of the bricks may be in a range of 2-12 inches, and the width may be in a range of 1-5 inches. In an example, the height is about 0.25 inch, the length is about 7.5 inch, and the width is about 2.25 inches. FIG. 9B, at 810-1, shows an roller extruder 903 having a plurality of shaping dies 904 arranged to provide a plurality of extruded bricks in a bond pattern to template 901 and/or open-weave mesh 205 as template 901 moves toward extruder 903 in the direction A-A. As template 901 moves under extruder 903, the composition for forming bricks 901 is extruded through shaping dies 904 to be positioned onto template 901 and/or open-weave mesh 205 in a bond pattern. Extruder 903 may rotate in direction B-B about an axis to continuously provide extruded bricks onto template 901 and/or open-weave mesh 205.

At 812, the plurality of bricks are positioned on the open-weave mesh in the bond pattern. Example bond patterns include any one of a running bond brick pattern, a common bond brick pattern, an English bond brick pattern, a flemish bond brick pattern, and a stack bond brick pattern. A space for a mortar joint is defined by adjacent bricks of the plurality of plurality of bricks. The plurality of bricks may be coupled to the open-weave mesh in a bond pattern where the space for a mortar joint is defined by adjacent bricks of the plurality of plurality of polymer bricks. In an embodiment, the space between adjacent bricks is in a range of 0.2-0.8 inches (0.5 mm-20 mm). The space may form the general shape of a channel between the plurality of bricks.

In an example, as shown at 812-1 in FIG. 9B, the bond pattern may be formed of a plurality of rows of bricks each having an equal number of bricks, where each row of bricks is offset such that a perimeter of the bricks forms gaps for receiving a brick from an adjacent cladding system. Each row does not need to have an equal number or size or brick as other bond patterns may be used to arrange bricks 201. As shown in FIG. 5, open-weave mesh 205, and bricks 201 positioned thereon, define gaps 209 on the lateral sides of open-weave mesh 205 for receiving projections 210 of adjacent open-weave mesh and bricks of cladding system 200. Similarly, projections 210 shown in FIG. 5 fit within a gap 209 of an adjacent open-weave mesh and bricks of cladding system 200.

At 814, the plurality of bricks are coupled to the open-weave mesh. In an example, after extrusion, bricks 901 have not yet been cured and are malleable for receiving open-weave mesh 205 as bricks 901 and open-weave mesh 205 are pressed together.

At 816, the plurality of bricks are cured with a heater. The heater may be a convection heater, radiant heater, or similar heat source. In an embodiment, curing the plurality of with a heater comprises heating the plurality of bricks to a temperature greater than 50° C., preferable at least 55° C. As shown in FIG. 9, at 816-1, heater 902 may heat the plurality of bricks 201 to cure the bricks while they are positioned on template 901. Once cured, the cladding system is ready for transport. The templates 901 may be separated (de-coupled from adjacent templates) and transported, e.g. to a worksite, with the cladding system positioned on the template which may preserve the shape of the cladding system during transport.

At 818, the plurality of bricks and open-weave mesh are removed from the template for installation.

### ALTERNATE EMBODIMENTS

The above description is meant to be exemplary only, and one skilled in the relevant arts will recognize that changes may be made to the embodiments described without departing from the scope of the invention disclosed. The present disclosure may be embodied in other specific forms without departing from the subject matter of the claims. The present disclosure is intended to cover and embrace all suitable changes in technology. Modifications which fall within the scope of the present invention will be apparent to those skilled in the art, in light of a review of this disclosure, and such modifications are intended to fall within the appended claims. Also, the scope of the claims should not be limited by the preferred embodiments set forth in the examples, but should be given the broadest interpretation consistent with the description as a whole.

As can be understood, the detailed embodiments described above and illustrated are intended to be examples only. The invention is defined by the appended claims.

The claims are not intended to include, and should not be interpreted to include, means-plus-or step-plus-function limitations, unless such a limitation is explicitly recited in a given claim using the phrase(s) “means for” or “step for,” respectively.

What is claimed is:

1. A cladding system for finishing an Exterior Insulation Finish Systems (EIFS), the cladding system comprising:
a plurality of bricks coupled to an open-weave mesh in a bond pattern where a space for a mortar joint is defined by adjacent bricks of the plurality of plurality of polymer bricks, the plurality of bricks each having a length, width, and height;
the open-weave mesh defining a plurality of holes, each of the plurality of holes having an area configured to allow a mortar to pass through the holes to extend at least of the height of the polymer bricks; and
the mortar configured to adhere to the open-weave mesh and the plurality of bricks to couple the open-weave mesh the plurality of bricks to a substrate, the mortar having a viscosity to pass through the holes to extend at least to the height of the polymer bricks to provide a grout in the space for the mortar joint.

2. The system as defined in claim 1, wherein the open-weave mesh is a glass fiber reinforcing mesh, the glass fiber comprises fiberglass in a range of 70-90% and polymer in a range of 10-30%, optionally, the open-weave mesh comprises about 81% fiberglass and 19% fluropolymer.

3. The system of claim 1, wherein the open-weave mesh is a first open-weave mesh, and wherein the first open-weave mesh is cut in a pattern configured to interlock a second open-weave mesh of the cladding system.

4. The system of claim 1, wherein the plurality of bricks comprises about 10-25 wt % polymer, about 15-30 wt % calcium carbonate, about 45-60 wt % silica sand, about 0.1-10% water, about 0-5 wt % rheology modifier, and about 1-10% catalyst.

5. The system of claim 4, wherein the polymer is at least one of an acrylic, a styrene acrylic, and polyurethane.

6. The system of claim 4, wherein the first rheology modifier is at least one of cellulose ether, Hydroxyethylmethyl cellulose (HEMC), Hydroxypropylmethyl cellulose (HPMC), Hydroxyethyl cellulose (HEC), attapulgite, bentonite, hectorite, and sepiolite, and alkali-soluble/alkali swellable thickeners.

7. The system of claim 4, wherein the catalyst is a powdered pozzolanic material comprising at least one of volcanic ash, pumice, opaline shales, slag, burnt clay, fly ash, metakaolin, silica fume, non-ferrous slag, and portland cement.

8. The system of claim 4, wherein the plurality of bricks comprise a base comprising at least one of the rheology modifier, a dispersing agent, a solvent, a surfactant, an in-can preservative, a dry film preservative, a rust inhibitor, a coalescing agent, and a pH adjuster.

9. The system of claim 8, wherein the dispersing agent comprises at least one of polyacrylates, polyester, polyether, polyurethane, hydrophobic copolymer polyeclectrolyte, polyacid homopolymer, polyacid copolymer, and polycarboxylic acid;
wherein the solvent comprises at least one of an e-series glycol ether and a p-series propylene glycol ether;
wherein the surfactant comprises at least one of:
a non-ionic surfactant comprising a hydrophilic carboxylate, sulfate, sulfonate, quaternary ammonium;
an ionic surfactant comprising an anionic and cationic surfactant;
an amphoteric surfactant; and
phosphate ester neutralized salt;
wherein the in-can preservative comprises isothiazolinone including at least one of methylisothiazolinone (MIT), 2-methy-1,2-benzisothiazolin-3-one (MBIT), methylchloroisothiazolinone (CMIT), benzisothiazolinone (BIT), and octylisothiazolinone (OIT), sodium hypochlorite, quaternary ammonium compounds, benzyl-C8-C18-alkyldimethyl, chlorides;
wherein the dry film preservative comprises at least one of iodopropynyl butylcarbamate (IPBC), octyl isothiazolinone (OIT), Zinc pyrithione (ZPT), and dichloro octyl isothiazolinone (DCOIT);
wherein the rust inhibitor comprises at least one of a inorganic rust inhibitors comprising at least one of a nitrite, nitrate, chromic salt, and phosphate; and/or an organic amine, wherein the nitrite is optionally calcium nitrite, wherein the phosphate is optionally at least one of sodium monofluorophosphate (Na₂PO₃F)(MFP), disodium hydrogen phosphate (Na₂HPO₄)(DHP), and trisodium phosphate (Na₃PO₄)(TSP);
wherein the pH adjuster comprises at least one of ammonia, 2-amino-2-methyl-1-propanol; and
wherein the coalescing agent comprises at least one of ester alcohol, ethylene glycol monobutyl ether, diethylene glycol monobutyl ether, an acrylic coalescing agent, dipropylene glycol dimethyl ether (DMM), and dipropylene glycol n-butyl ether (DPnB).

10. The system of claim 1, wherein the height of each of the plurality of bricks is in a range of 0.2-1 inch, preferably the height is about 0.25 inch.

11. The system of claim 1, wherein the area of each of the plurality of holes is greater than 0.4 inch², and wherein the space is in a range of 0.2-0.8 inches (0.5 mm-20 mm), preferably the area of each of the plurality of holes is about 0.6 inch².

12. The system of claim 1, wherein the bond pattern is any one of a running bond brick pattern, a common bond brick pattern, an English bond brick pattern, a flemish bond brick pattern, and a stack bond brick pattern.

13. The system of claim 1, wherein the mortar comprises: a pozzolanic material, silica sand, a second rheology modifier, redispersible polymer, calcium carbonate, a calcium inosilicate mineral, wherein the mortar comprises 30-35 wt % pozzolanice material, 40-50 wt % silica sand, 0.1-1 wt % rheology modifier, 2-5% redispersible polymer, about 0.5-1% calcium inosilicate mineral, and 10-15 wt % calcium carbonate.

14. The system of claim 13, wherein the pozzolanice material comprises at least one of volcanic ash, pumice, opaline shales, slag, burnt clay, fly ash, metakaolin, silica fume, non-ferrous slag, and portland cement.

15. The system of claim 13, wherein the second rheology modifier is at least one of Hydroxyethylmethyl cellulose (HEMC), Hydroxypropylmethyl cellulose (HPMC), Hydroxyethyl cellulose (HEC), Attapulgite, bentonite, hectorite, and sepiolite.

16. The system of claim 13, wherein the redispersible polymer is at least one of ethylene vinyl acetate copolymer (EVA); vinyl acetate/ethylene/vinyl ester of versatic acid terpolymer (VAC/E/VeoVa); vinyl acetate/vinyl ester of versatic acid terpolymer copolymer (VAc/VeoVa), and polyvinyl acetate polymer (PVAC).

17. The system of claim 13, wherein the calcium inosilicate mineral is Wollastonite.

18. The system of claim 13, wherein the mortar comprises 3-5 wt % recycled material, the recycled material comprising at least one of glass and any one of polyester, nylon, cotton, wool and down fibers.

19. A method for manufacturing a cladding system for an Exterior Insulation Finish Systems (EIFS), the method comprising:
providing a composition for forming a brick;
providing a plurality of templates for a bond pattern, the plurality of templates configured to interlock to form a continuous surface when one of the plurality of templates interlock with the other of the plurality of templates;
positioning an open-weave mesh onto the template;
extruding the composition to form a plurality of bricks, each of the bricks having a length, width, and height;
positioning the plurality of bricks on the open-weave mesh in the bond pattern, the where a space for a mortar joint is defined by adjacent bricks of the plurality of plurality of bricks;
coupling the plurality of bricks to the open-weave mesh;
curing the plurality of bricks with a heater, wherein curing the plurality of with a heater comprises heating the plurality of bricks to a temperature greater than 50° C., preferrably at least 55° C.; and
cutting the open-weave mesh in the bond pattern.

20. The method of claim 19, comprising removing the plurality of bricks and open-weave mesh from the template.

21. The method of claim 19, wherein the open-weave mesh defines a plurality of holes, each of the plurality of holes having an area configured to allow a mortar to pass through the holes to extend at least of a height of the polymer bricks, wherein the plurality of bricks are coupled to the open-weave mesh in a bond pattern where a space for a mortar joint is defined by adjacent bricks of the plurality of plurality of polymer bricks, the plurality of bricks each having a length, width, and height.

22. The method of claim 19, comprising continuously interlocking the plurality of templates to form the continuous surface on which the open-weave and the plurality of bricks are positioned in a continuous process, wherein the open-weave mesh is a first open-weave mesh, and wherein the first open-weave mesh is cut in a pattern configured to interlock a second open-weave mesh of the cladding system.
